(19) United States
(12) Patent Application Publication
(10) Pub. No.: US 2016/0211558 A1
(43) Pub. Date: Jul. 21, 2016

(54) BATTERY THERMAL MANAGEMENT SYSTEMS, APPARATUSES, AND METHODS

(71) Applicant: THE REGENTS OF THE UNIVERSITY OF CALIFORNIA, Oakland, CA (US)

(72) Inventor: Yanbao Ma, Merced, CA (US)

(21) Appl. No.: 14/915,608

(22) PCT Filed: Sep. 9, 2014
(86) PCT No.: PCT/US14/54826

§ 371 Date: Feb. 29, 2016

Related U.S. Application Data
(60) Provisional application No. 61/875,222, filed on Sep. 9, 2013.

(51) Int. Cl. H01M 10/6556; H01M 10/625; H01M 10/6568; H01M 10/615; H01M 10/63; H01M 10/613; H01M 10/48

(52) U.S. Cl. CPC H01M 10/6556; H01M 10/613; H01M 10/625; H01M 10/486; H01M 10/615; H01M 10/63; H01M 10/6568; H01M 2220/20

(57) ABSTRACT

Generally discussed herein are Battery Thermal Management (BTM) devices, systems, and methods. A BTM device can include one or more battery cells, and one or more minichannel tubes attached to the one or more battery cells so as to thermally contact to the one or more battery cells, such as to maintain the one or more battery cells within a predetermined temperature range.

### RELATED APPLICATION

This application claims priority to U.S. Provisional Patent Application No. 61/875,222, entitled “A BATTERY THERMAL MANAGEMENT SYSTEM BASED ON MINI-CHANNEL TECHNOLOGY,” and filed on Sep. 9, 2013, which is incorporated herein by reference in its entirety.

### BACKGROUND

A Battery Thermal Management System (BTMS) is one of the important components for Electric Vehicles (EVs) to achieve high performance and/or maintain vehicle safety under various operating conditions. An EV can include a Battery EV (BEV) or a Hybrid EV (HEV) (e.g., a plug-in or non-plug-in HEV).

An EV can have reduced emissions as compared to a gas, diesel, or other fuel-powered vehicle. Some EVs can even include zero emissions and can play an important role in achieving an energy or greenhouse gas emission goal. EVs can also provide other benefits including improved energy security, improved environmental and public health quality, and reduced fueling and maintenance costs.

### BRIEF DESCRIPTION OF DRAWINGS

Various ones of the appended drawings illustrate embodiments of the subject matter presented herein. The appended drawings are provided to allow a person of ordinary skill in the art to understand the concepts disclosed herein, and therefore cannot be considered as limiting a scope of the disclosed subject matter.

FIG. 1 shows a graph of Li—Mn battery calendar life versus temperature at sixty percent state of charge (SOC).

FIG. 2 shows a graph of graphite-LiFePO₄ battery percent capacity loss measured at various temperatures versus total amp hour throughput per amp hour.

FIG. 3 shows a block diagram of a prior art battery cooling system.

FIG. 4 shows a block diagram of examples of minichannel tubes, in accord with one or more embodiments.

FIG. 5 shows an end-view diagram of a minichannel tube, in accord with one or more embodiments.

FIG. 6A shows a graph of heat transfer coefficient versus port width.

FIG. 6B shows a graph of a pressure drop versus port width.

FIG. 7 shows a block diagram of an example of a Battery Thermal Management BTM device, in accord with one or more embodiments.

FIG. 8 shows a block diagram of another example of another BTM device, in accord with one or more embodiments.

FIG. 9 shows a block diagram of another example of yet another BTM device, in accord with one or more embodiments.

FIG. 10 shows a block diagram of an example of yet another BTM device, in accord with one or more embodiments.

FIG. 11A shows a block diagram of an example of a battery cell, in accord with one or more embodiments.

FIG. 11B shows a block diagram of an example of another battery cell, in accord with one or more embodiments.

FIG. 12 shows a block diagram of an example of a BTMS, in accord with one or more embodiments.

FIG. 13 shows a block diagram of another example of a BTMS, in accord with one or more embodiments.

FIG. 14A shows a simulated thermal diagram of a cell including minichannel tubes, in accord with one or more embodiments.

FIG. 14B shows a simulated thermal diagram of a temperature gradient at and near an edge of a minichannel tube, in accord with one or more embodiments.

FIG. 15 shows a flow diagram of an example method of using a BTMS, in accord with one or more embodiments.

### DETAILED DESCRIPTION

The description that follows includes illustrative apparatuses, systems, methods, and techniques that embody various aspects of the subject matter described herein. In the following description, for purposes of explanation, numerous specific details are set forth to provide an understanding of various embodiments of the subject matter. It will be evident, however, to those skilled in the art that embodiments of the subject matter can be practiced without at least some of these specific details.

This disclosure relates generally to the field of battery thermal management (BTM) and more specifically to systems, apparatuses, and methods related to including one or more minichannels in a BTMS.

Energy consumption for the transportation sector is responsible for almost 40% of all greenhouse gas (GHG) emissions and more than 50% of all air pollution in California. According to the California Air Resource Board, EVs are 65% to 70% lower in full fuel cycle emissions than conventional vehicles (based on California's electricity grid at the time of the study). Thus, EVs are a promising, and potentially revolutionary key to the success of the California economy and stabilization of its climate. The continuous development effort for affordable robust and reliable EV batteries can greatly accelerate widespread EV adoption, which can provide significant benefits to California, as well as other regions of the world, including improved energy security, improved environmental and public health quality, reduced auto fueling and maintenance costs, and strengthening the leading role of California in renewable/green energy and automobile industry. Similar benefits can be realized elsewhere, California is merely used as a convenient example region where EVs and the subject matter discussed herein can have an impact.

Notwithstanding the foregoing, there are at least two problems facing widespread adoption of EVs: 1) the high cost of battery packs and 2) short battery life with limited warranty (e.g., about 8 years). Some or all traditional cooling systems for EV batteries, such as air cooling with an electric fan, liquid cooling system with water, glycol, oil, acetone, and refrigerants, heat pipe cooling, and phase change material (PCM) cooling, have been studied and their performances have been reviewed. As discussed herein, one or more of the BTM systems, apparatuses, and methods discussed herein can outperform these traditional cooling systems in terms of temperature regulation consistency, cost, or power efficiency.

Different battery manufacturers and vehicle developers have adopted various strategies for thermal management. For the cooling medium, air and liquid coolant are both used. It is generally accepted that the simpler air-cooled systems will be somewhat lower in cost than liquid cooling. However, liquid cooling is generally more efficient in terms of power and temperature regulation than air cooling. For example, in 2012, there were 112 documented cases of battery capacity loss of one or more bars reported by Nissan Leaf customers from hotter climates (mainly in Arizona, Texas, and California in the United States). The battery capacity loss was attributed to poor air cooling. For EV batteries, active, fluid-based systems are beneficial for improving battery performance (e.g., life and capacity) under some more extreme temperature conditions, such as those conditions often experienced in summer in the southern U.S.A. To handle these sorts of conditions, a BTM unit should be able to handle a large range of temperatures, such as temperatures between about −30 degrees Celsius to about 50 degrees Celsius.

Lithium-ion (Li-ion) batteries offer relatively high power and energy density, as well as high power discharge, as compared to other battery types. This capability of Li-ion batteries makes them a promising candidate for EVs. However, for increased battery life, the temperature of a Li-ion battery can benefit from being maintained in a specific range of temperatures (e.g., in the range of about 20 degrees Celsius to about 30 degrees Celsius), such as to help increase battery life or performance The battery can benefit from remaining in a specific temperature range even when no power is being drawn from the battery.

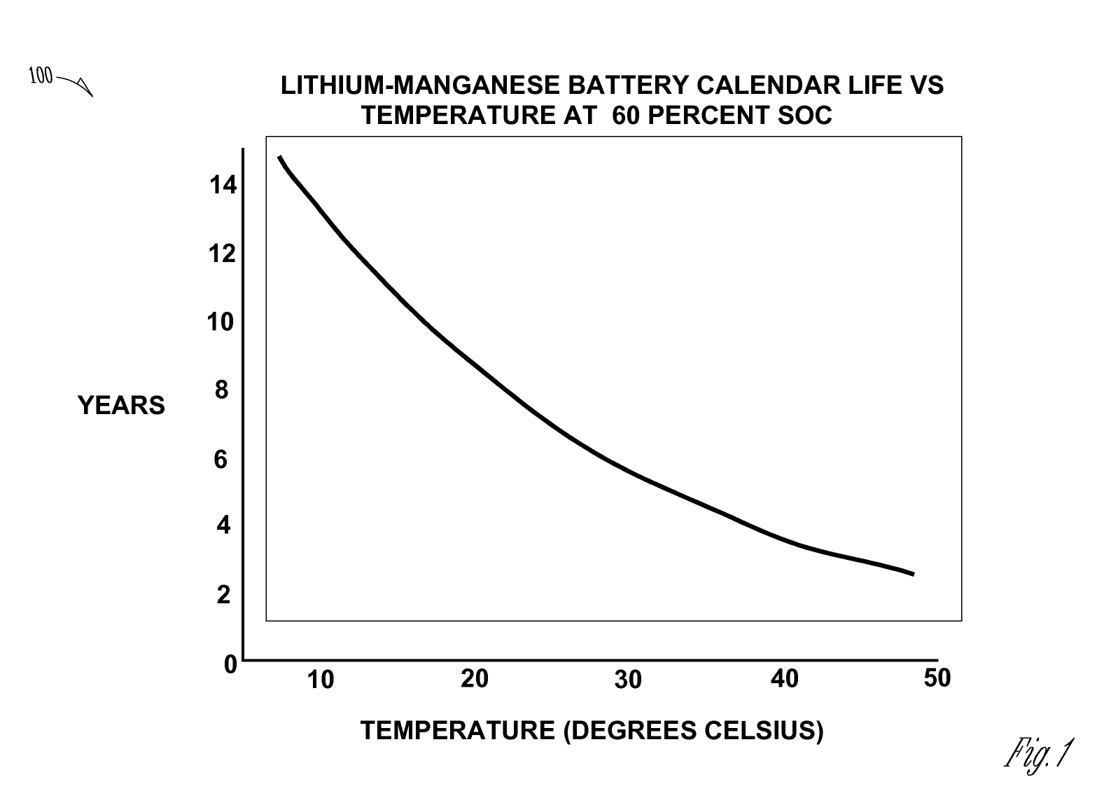

The end of life (EOL) of a battery is typically defined as the time when about 20% capacity loss or about 30% internal resistance is reached. The capacity of EV batteries decreases over time as the internal resistance of the battery increases over the same time. This trend is generally independent of whether the battery is being used or stored without use. This condition is commonly referred as “calendars fade”, since a corresponding battery life relates generally to a calendar life. FIG. 1 shows a typical graph 100 with a curve for a Lithium-Manganese (Li—Mn) battery calendar life versus temperature at 60% state of charge (SOC). Li—Mn batteries have a little over an 8-year life (e.g., on average) at 22 degrees Celsius, but have only a 5-year life at 32 degrees Celsius. If the average SOC over time is greater than 60% SOC, calendar life can be less than that shown in FIG. 1. There are similar trends for battery life vs. temperature for other types of Li-ion batteries. Note that SOC indicates, like a fuel gauge in a gas powered vehicle, how much “fuel” there is available relative to a maximum amount (100 percent). Thus, 60% SOC indicates that 60% of a maximum total battery charge is available.

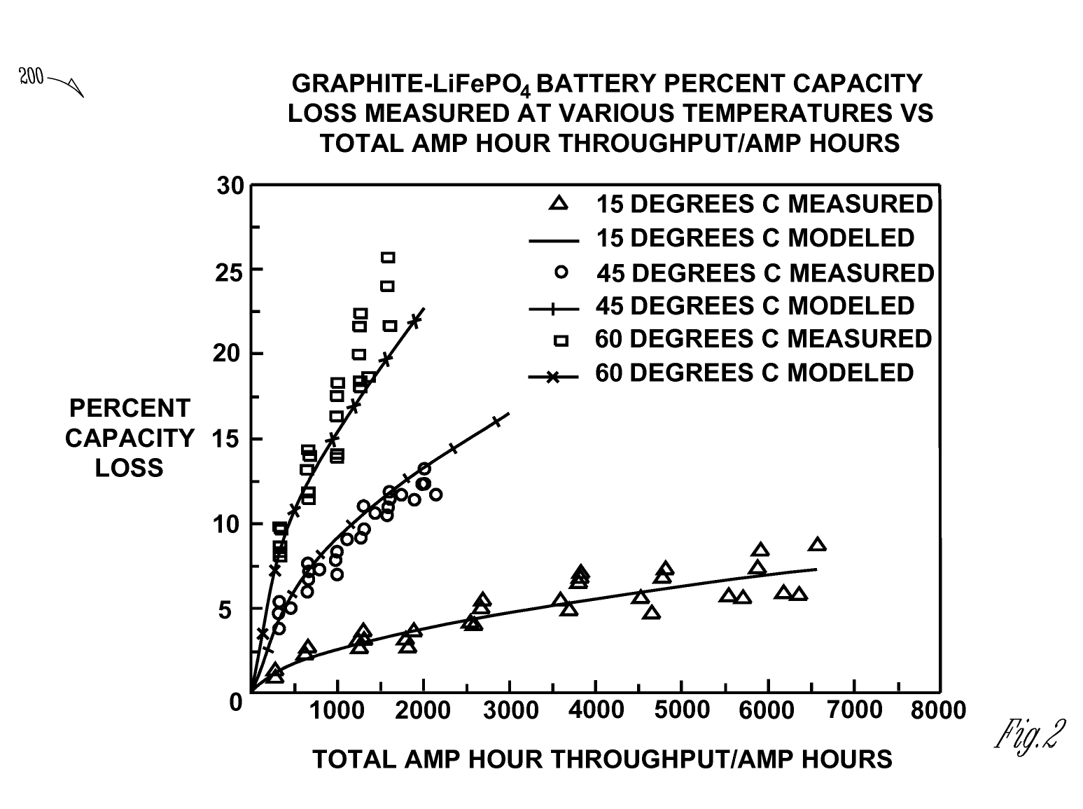

Batteries also degrade with usage, which is known as “cycle fade”. A corresponding lifetime is battery cycle life. FIG. 2 shows a graph 200 that compares the predictions of graphite-LiFePO₄ battery cycle life against experimental data at three different temperatures: 15 degrees Celsius, 45 degrees Celsius and 60 degrees Celsius. The graph 200 shows that battery capacity loss increases (or cycle life decreases) with increasing temperature.

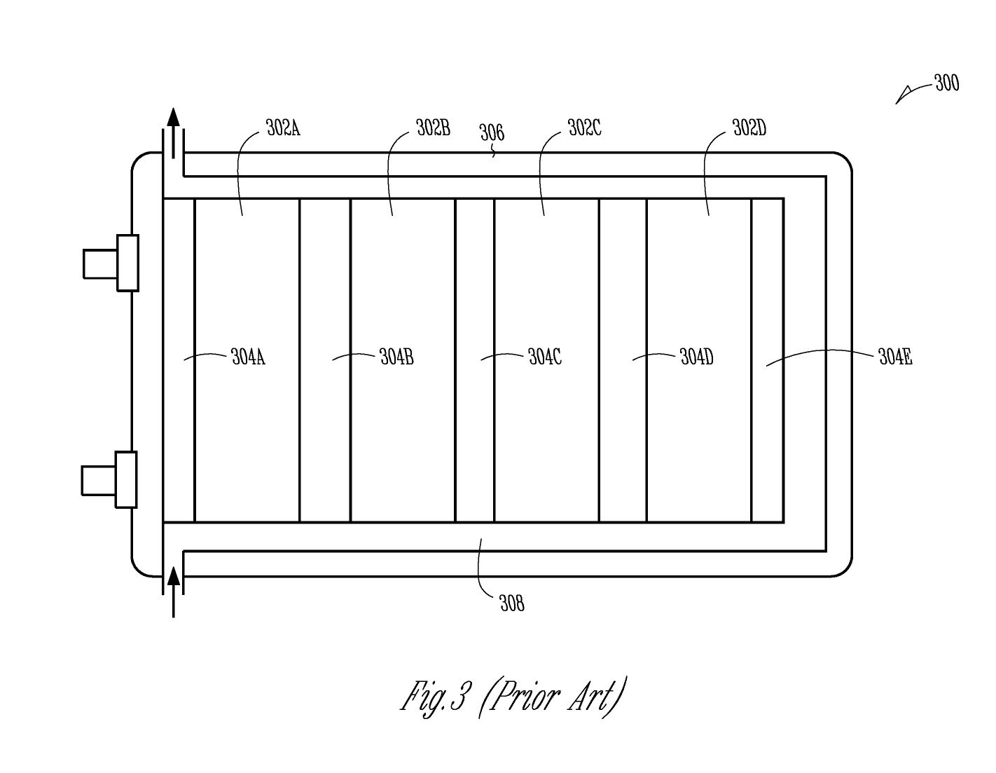

FIG. 3 illustrates a prior art battery cooling system 300 including a cell module and pack with conventional liquid cooling at the pack level. Cells 302A, 302B, 302C, and 302D are placed on their sides in the module and separated by aluminum conduction channels 304A, 304B, 304C, 304D, and 304E. The aluminum conduction channels 304A-E assist in heat rejection from sides of cells. The gaps between cells 302A-D and a pack jacket 306 form a passage 308 for a coolant which cools down or heats up the battery 300 from the sides of the cell 302A-D. The arrows indicate a flow of coolant in and out of the passage 308. An ethylene-glycol/water (EG/W) solution is commonly used as the coolant for the battery pack 300. For this type of design, cells 302A-D are enclosed in hermetically sealed modules and a polymer sealant is used between different modules to block flow and prevent coolant from contacting module terminals or their interconnections. Otherwise, leaks of the EG/W solution can short the cells 302A-D and can potentially cause danger.

There are at least four problems with the conventional BTM, such as the one shown in FIG. 3, that have been considered in a BTM design discussed herein: 1) the BTMS designed at pack level can lead to uneven temperature distribution (a temperature distribution of about ten degrees Celsius or more can be experienced within a single cell of the pack); 2) localized deterioration in the battery pack; 3) the hermetical design of modules and pack jacket cause a high material or manufacturing cost; and 4) the conventional liquid ducting design leads to an increase in weight and non-compact volume of a BTMS.

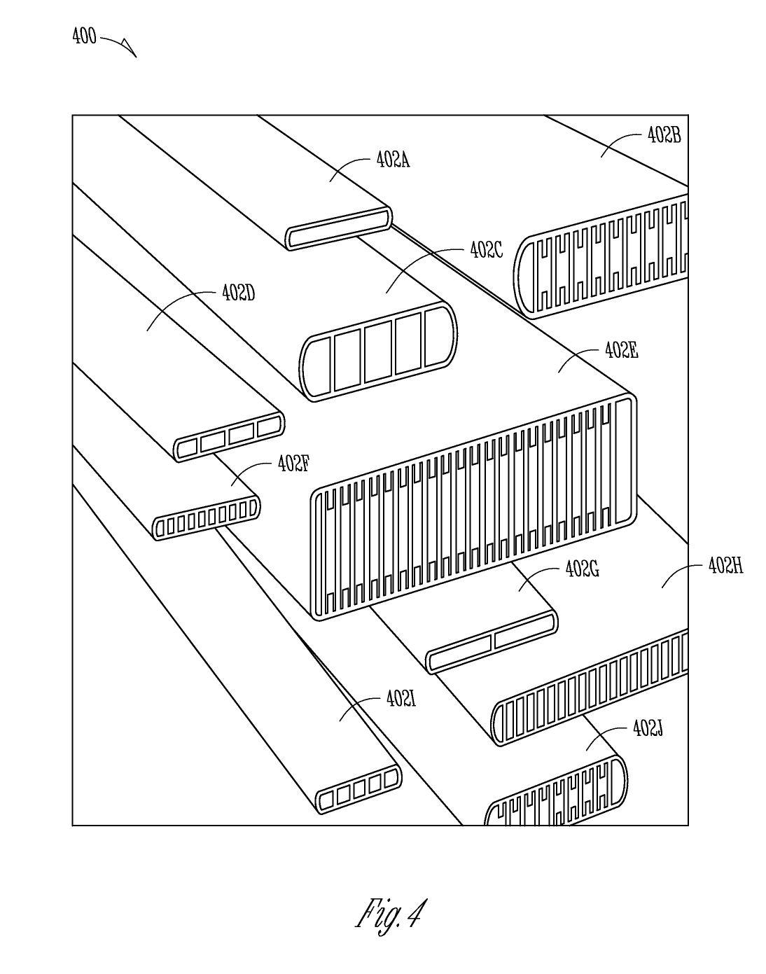

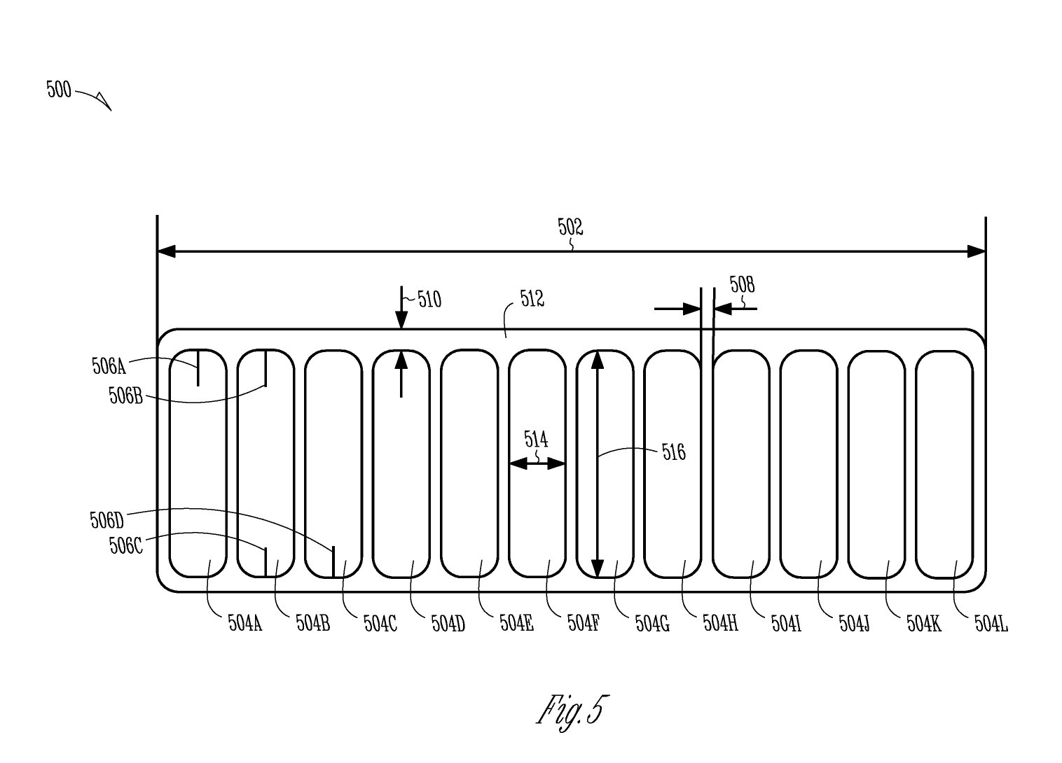

To overcome one or more of the disadvantages discussed, a battery that includes a minichannel tube (e.g., a microchannel tube) is proposed. FIG. 4 shows an example of a variety of minichannel tube configurations 400, in accord with one or more embodiments. A minichannel tube 402A, 402B, 402C, 402D, 402E, 402F, 402G, 402H, 402I, and 402J is a single port tube or multiport tube with a port width or inner hydraulic diameter in the range of, for example, tens of micrometers to tens of millimeters. Many minichannels include hydraulic diameters of between 0.2 millimeters to about 3 millimeters. The minichannel tube 402A-J can include a variety of port shapes and sizes. The minichannel tube 402A-J can include a generally rectangular, elliptical, or other shaped port that can include generally square or rounded corners or sides. The port can include a protrusion that can help in reducing turbulence or helping with laminar flow. More details regarding a minichannel tube are discussed with regard to FIG. 5 and elsewhere herein.

FIG. 5 shows an end-view of an example of a minichannel tube 500, in accord with one or more embodiments. The minichannel tube 500 can include one or more ports 504A, 504B, 504C, 504D, 504E, 504F, 504G, 504H, 504I, 504J, 504K, or 504L. The port 504A-L can include a protrusion 506A, 506B, 506C, or 506D extending into the interior of the port 504A-L. While FIG. 5 depicts at most two protrusions 506B-C in a port 504A-C and depicts that protrusions 506A-D as generally linear, a person of ordinary skill in the art, upon reading and understanding the detailed description provided herein, will recognize that different sizes, shapes, and numbers of protrusions can be used in a port 504A-L. The number and shape of the protrusions 506A-D can be configured to help a flow include a fluid (e.g., liquid or gas) with less turbulent flow in the associated port 504A-L.

The minichannel tube 500 can include dimensions that can be related to the thermal conductivity performance and in determining a maximum pressure which the minichannel tube 500 can withstand. The dimensions can include an overall width 502 (W), a spacing 508 (W_{w}) between ports, a sidewall thickness 510 (Wₜ) 512, a width 514 (W_{c}) of the port 504A-K, and a height 516 (H_{c}) of the port 504A-K. In one or more embodiments, the width 514 can be between about tens of micrometers to about tens of millimeters. In or more embodiments, the width 614 can be between about 0.2 millimeters to about 3 millimeters. The sidewall thickness 512 can be a variety of thicknesses with a thicker sidewall being able to withstand higher pressures at the expense of a reduced thermal conductivity. In one or more embodiments, the thickness of the sidewall 512 can be between about 100 micrometers and about 200 micrometers.

Depending upon factors such as fluid pressure within the port 504A-K or a thermal conductivity requirement, a sidewall thickness 510, or port spacing 508 can be determined A thinner sidewall thickness 510 can improve heat transfer (e.g., thermal conductivity). A thicker sidewall thickness 510 or port spacing 508 can help a minichannel tube 500 withstand higher fluid pressures. The minichannel tube 500 generally has a high thermal efficiency (high thermal conductivity), low material cost and weight, and a compact design. Another consideration in minichannel design can include an increased port width 514 decreasing the pressure in the port 504A-K.

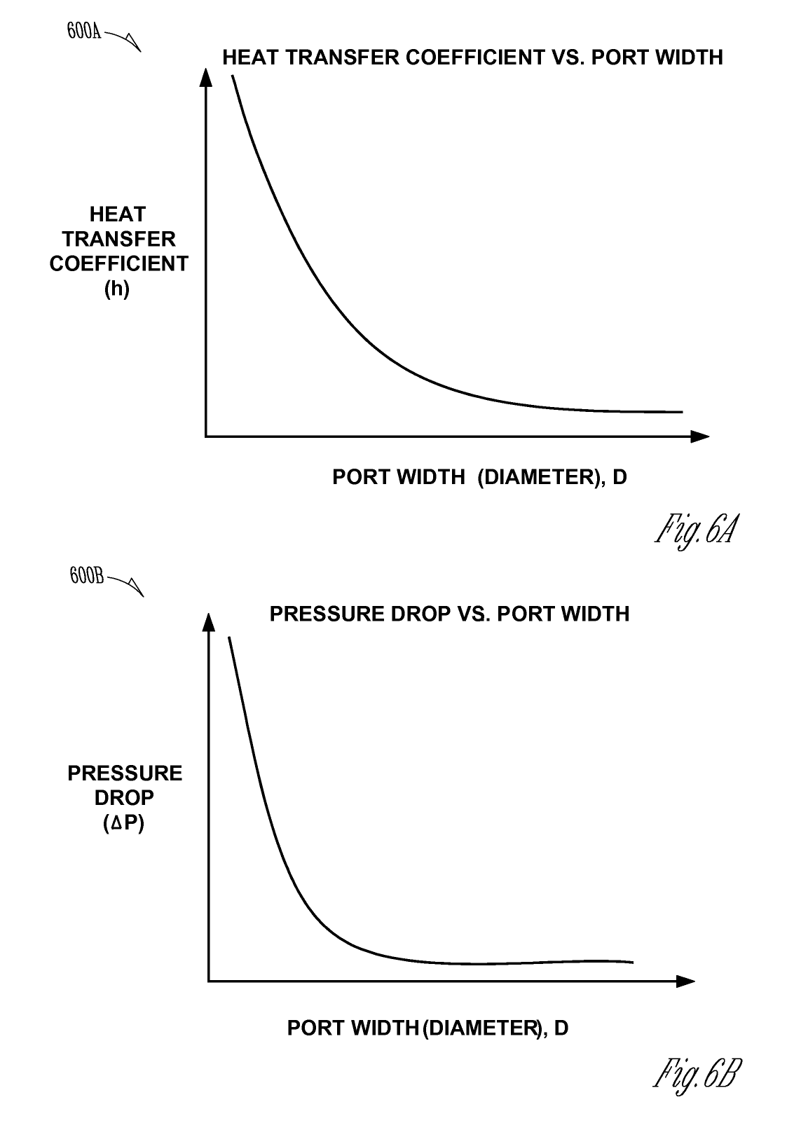

FIG. 6A shows a graph 600A of a heat transfer coefficient (h) vs. port width 514. As is shown in the graph 600A, the heat transfer coefficient (thermal conductivity) of the port 504A-K decreases as the port width 514 increases. FIG. 6B shows a graph 600B of a pressure drop (ΔP) vs the port width 514. As is shown in the graph 600B, the pressure drop decreases as the port width 514 decreases.

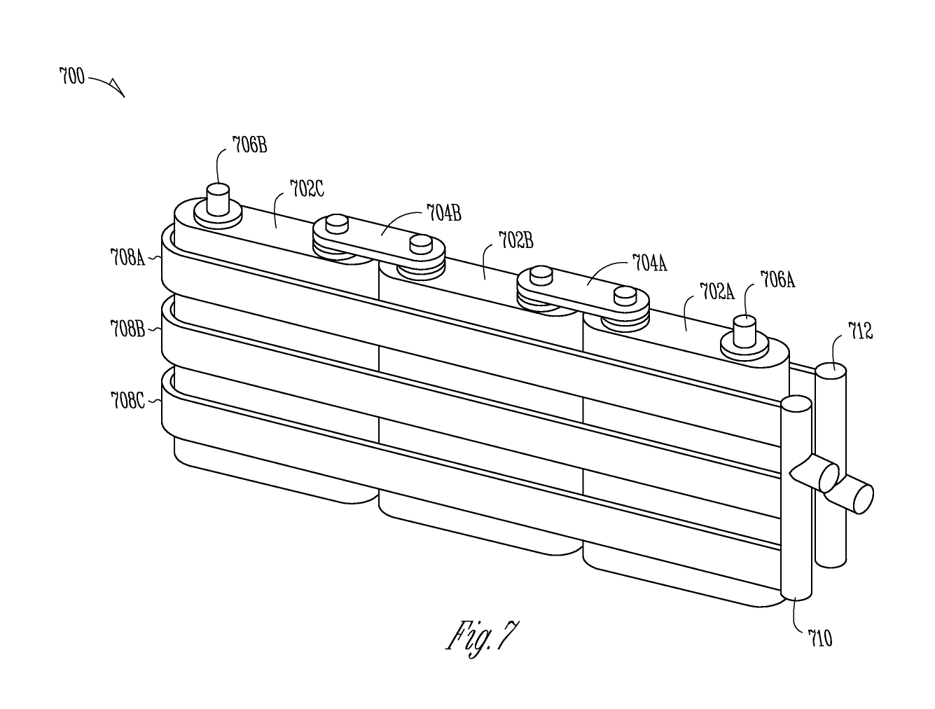

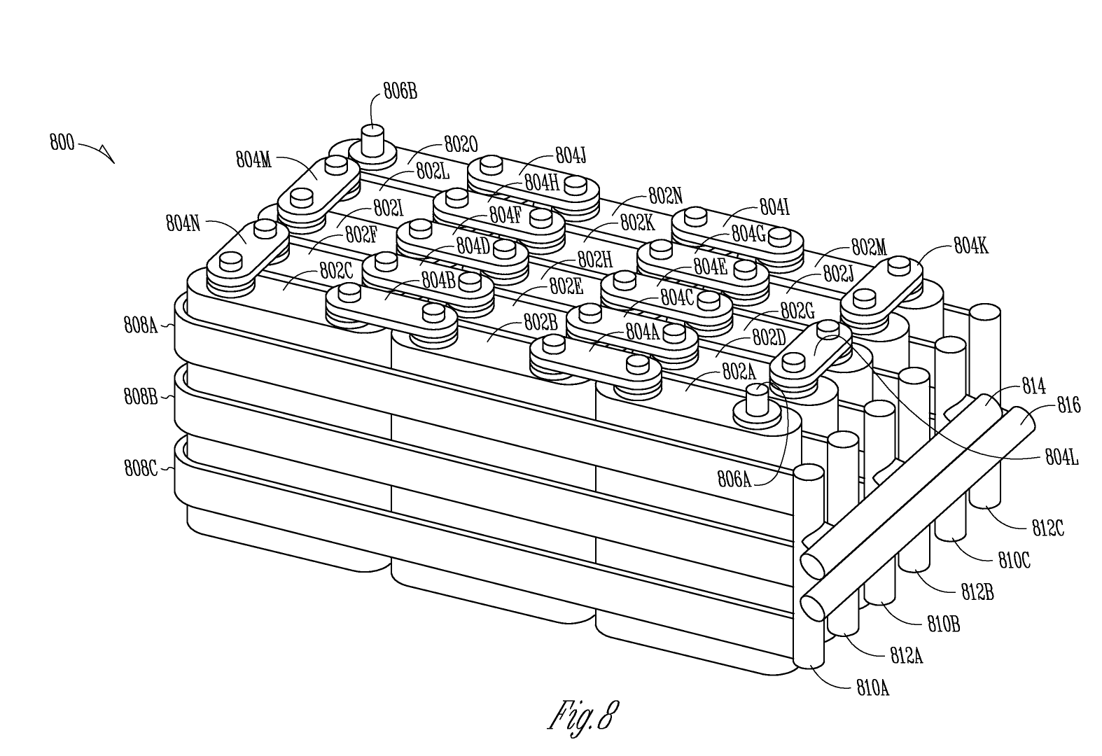

FIGS. 7 and 8 show examples of a portion of a BTM system 700 and 800, respectively, in accord with one or more embodiments. In various embodiments, minichannel tubes 708A, 708B, and 708C can be used in a BTMS with cooling/heating at the cell level (as shown in FIGS. 7 and 8, among others) as compared to the pack level (e.g., a cooling system as shown in FIG. 3). The BTM system 700 can include one or more battery cells 702A, 702B, or 702C coupled in series through battery connectors 704A and 704B. The system 700 can include a terminal 706A or 706B through which to access the electrical energy of the system 700.

One or more minichannel tubes 708A, 708B, or 708C can be thermally coupled to one or more of the cells 702A-C. The minichannel tubes 708A-C can be formed using a variety of materials including a polymer, plastic, carbon, aluminum or other metal, or a combination thereof. In one or more embodiments, the minichannel tube 708A-C can be formed to fit snugly around the cells 702A-C. In one or more embodiments, the minichannel tube 708A-C can be soldered, welded, glued, or otherwise attached to the cells 702A-C. The minichannel tube 708A-C can include a flat aluminum multiport minichannel tube (FAMMT), in one or more embodiments. The minichannel tubes 708A-C of FIG. 7 are generally “U” shaped (when view from a top-view of FIG. 7) and in contact (e.g., thermally coupled) with at least two sides of the cells 702A-C.

A thermal grease or sintered metal can help increase a thermal connection between a minichannel tube 708A-C and a cell 702A-C, such as at a location where there is a gap between a portion of the minichannel tube 708A-C and a corresponding cell 702A-C.

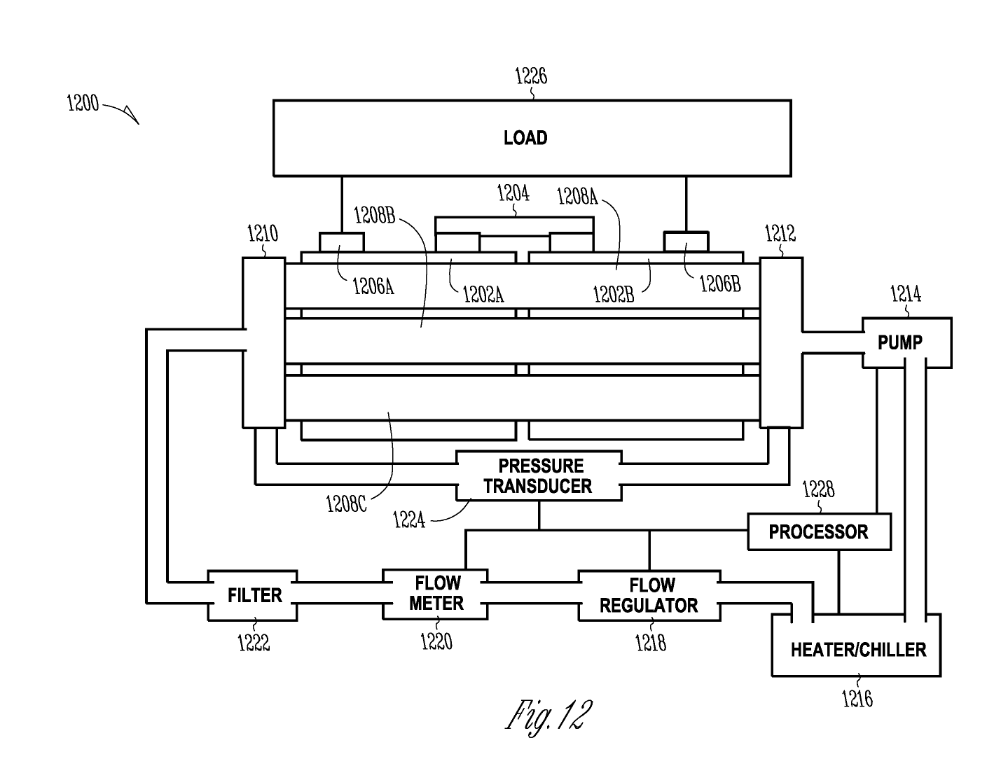

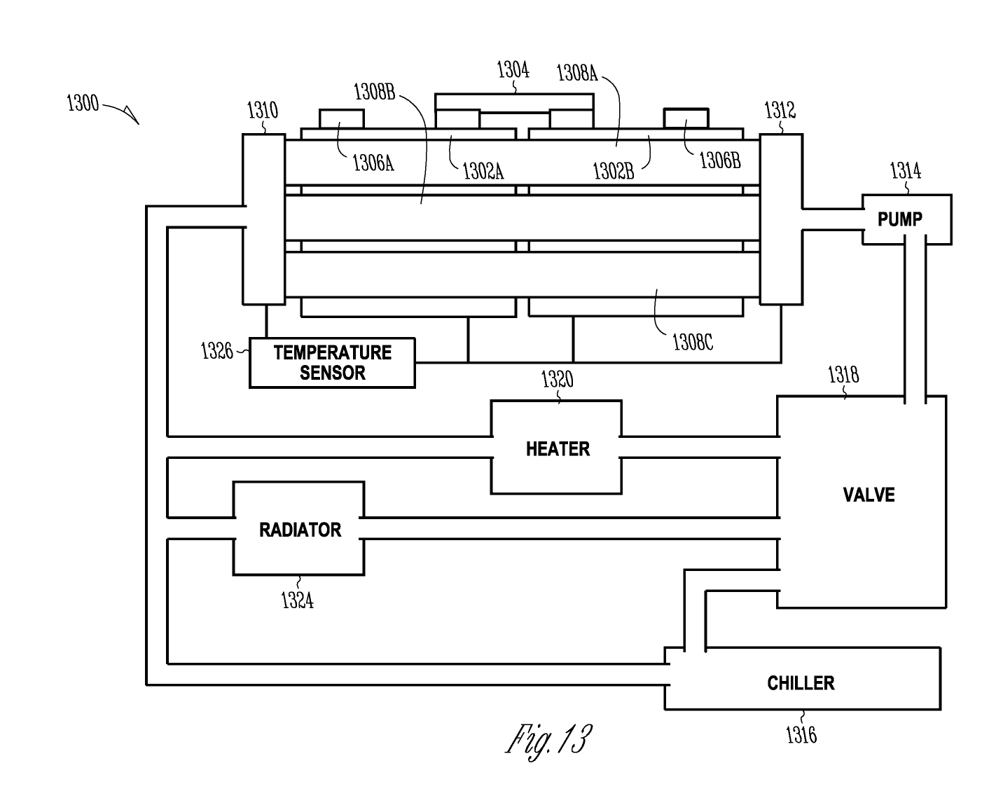

Each of the minichannel tubes 708A-C can be coupled to an input port 710 and an output port 712. The input port 710 can be coupled to a pump (not shown in FIGS. 7 and 8, see FIGS. 12 and 13) that can force fluid through the port 710 and the minichannel tube 708A-C. The output port 712 can help carry a fluid away from the minichannel tubes 708A-C.

Some advantages of using the one or more minichannel tubes 708A-C in a BTMS can include: (a) enhancing thermal efficiency using minichannels; (b) reducing uneven temperature distribution in a battery pack through more efficient cooling at the cell level; (c) removing the hermetical constraints of expensive design and manufacturing of cell modules and pack jackets, such as can be required in using a system like that shown in FIG. 3; (d) removing aluminum conduction channels of the prior art as shown in FIG. 3; (e) simplifying the overall design of the battery pack and the BTMS; (f) reducing the overall pack weight and volume; and (g) reducing the manufacturing cost of the battery and/or BTMS.

In addition the foregoing advantages, the coolant fluid of a BTMS that includes a minichannel tube can be enclosed in the minichannel fluidic system (e.g., a combination of one or more of an input port(s) 710, input tube(s) 814 (see FIG. 8), minichannel tube 708A-C, output port(s) 712-C, and output tube 816 (see FIG. 8), which not only reduces the risk of coolant contacting a cell terminal and their interconnections, but also simplifies the cell connection design. However, even if leakage considerations are considered, non-electrically conductive fluids can be used in the minichannel tubes 708A-C. For example, certain thermally conductive fluids such as mineral oil, transformer oil, various refrigerants, and so on can be employed. Further, other thermally conductive media such as fluid metal can be used as fluids in the minichannel tubes 708A-C as well. In one or more embodiments, a thermally-conductive gas may be employed as a coolant within the minichannel tubes.

Additionally, other types of minichannel tubes can be employed as well. For example, other materials with a good (e.g., approximately the same or better than the thermal conductivity of aluminum) thermal conductivity can be used to produce the minichannel tubes. Such materials can include, for example, copper, bronze, and other non-ferric and ferric materials, carbon-impregnated polymers or other thermally conductive plastics, and so on. However, for ease of understanding and brevity, minichannel tubes will be used herein with the understanding that the exact materials or geometries employed herein can be the same as or different from those found in commercially-available minichannel tubes.

As shown in FIG. 7, the minichannel tubes 708A-C can be located in close thermal proximity with the cell 702A-C at one or more multiple positions along the cell 702A-C. In various embodiments, the minichannel tubes 708A-C can be formed to mechanically conform closely to the shape of the minichannel tubes 708A-C. In other embodiments, the minichannel tubes 708A-C can be formed to have an increased radius with regard to certain geometries of the cell 702A-C, such as to help prevent a harmful pressure drop or to help maintain a laminar flow regime of the fluid within the minichannel tube.

Additionally, in various embodiments, the thermal conductance of coupling the minichannel tubes 708A-C to the cell 702A-C can be improved through the use of brazing, welding, soldering, or some other attachment mechanism between the minichannel tubes 708A-C and the cell 702A-C. In various embodiments, the thermal interface between the minichannel tube 708A-C and cell 702A-C can be improved through the use various types of thermally-conductive adhesives, grease, metal sintering, epoxies, or a combination thereof.

Generally, heat generated inside the cell 702A-C is transported to the minichannel tubes 708A-C through conduction, and then dissipated through fluid convection. The heat dissipation rate depends directly on a flow rate of the fluid which can be controlled by a closed-loop control system with a sensed temperature of the cell 702A-C as a control signal. A closed-loop control system is understood by a person of ordinary skill in the art based on closed loop control concepts known independently in the art.

FIG. 8 shows a system 800 similar to the system 700 with a plurality of rows of cells 802A A-F coupled together (in series) into a pack, while FIG. 7 shows a single row of cells 702A-C coupled together to form a pack. The cells 802A, 802B, 802C, 802D, 802E, 802F, 802I, 802J, 802K, 802L, 802M, 802N, and 802O can be substantially the same as the cells 702A-C and can be coupled in series through battery connectors 804A, 804B, 804C, 804D, 804E, 804F, 804G, 804H, 804I, 804J, 804K, 804L, 804M, or 804N which can be substantially similar to the connectors 704A-B. The system 800 can include a terminal 806A and 806B similar to the terminal 706A-B through which to access the electrical energy of the system 800A-B. The input ports 810A, 810B, and 810C can be coupled to a common input tube 814 and the output ports 812A, 812B, and 812C can be coupled to a common output tube 816, such as shown in FIG. 8. As used herein “substantially the same” means that the item can be made of the same or similar materials as the item it is substantially the same as. The minichannel tubes 808A-C of the system 800 can be in contact with adjacent rows of cells (e.g., cells 802A-C and 802D-F be independent rows of cells and can adjacent to each other). The minichannel tubes 808A-C can be configured to be thermally coupled (e.g., in thermal contact) with the row of cells 802A-C and the row of cells 802D-F, simultaneously.

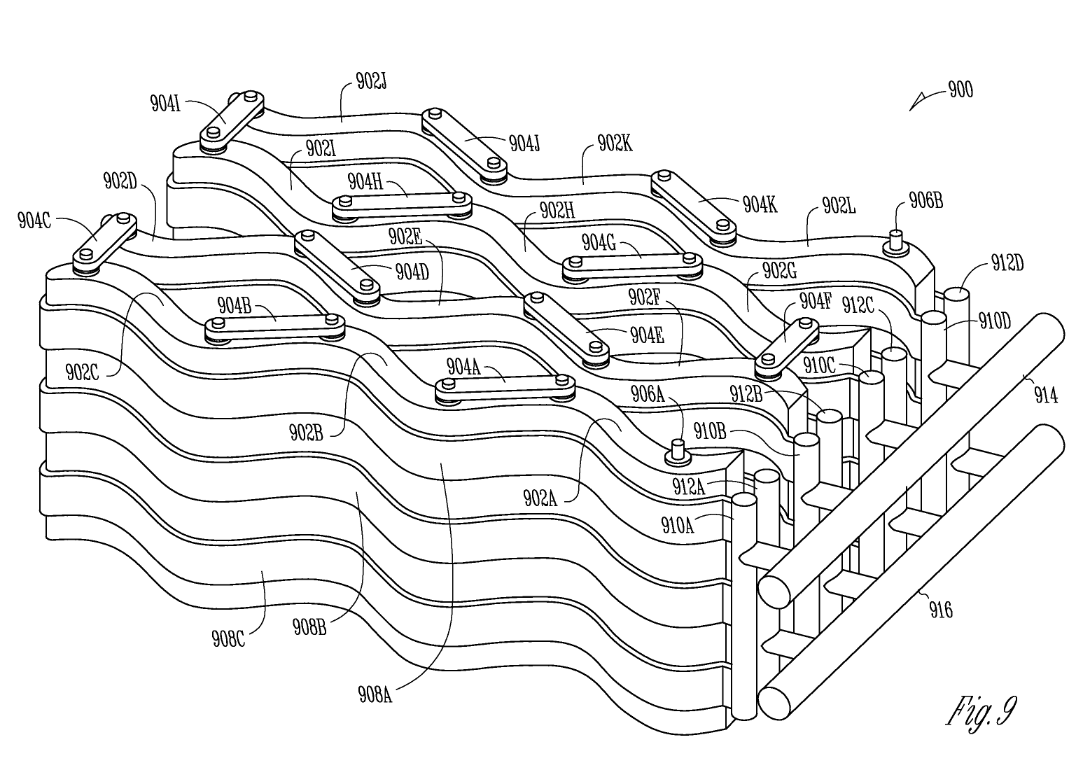

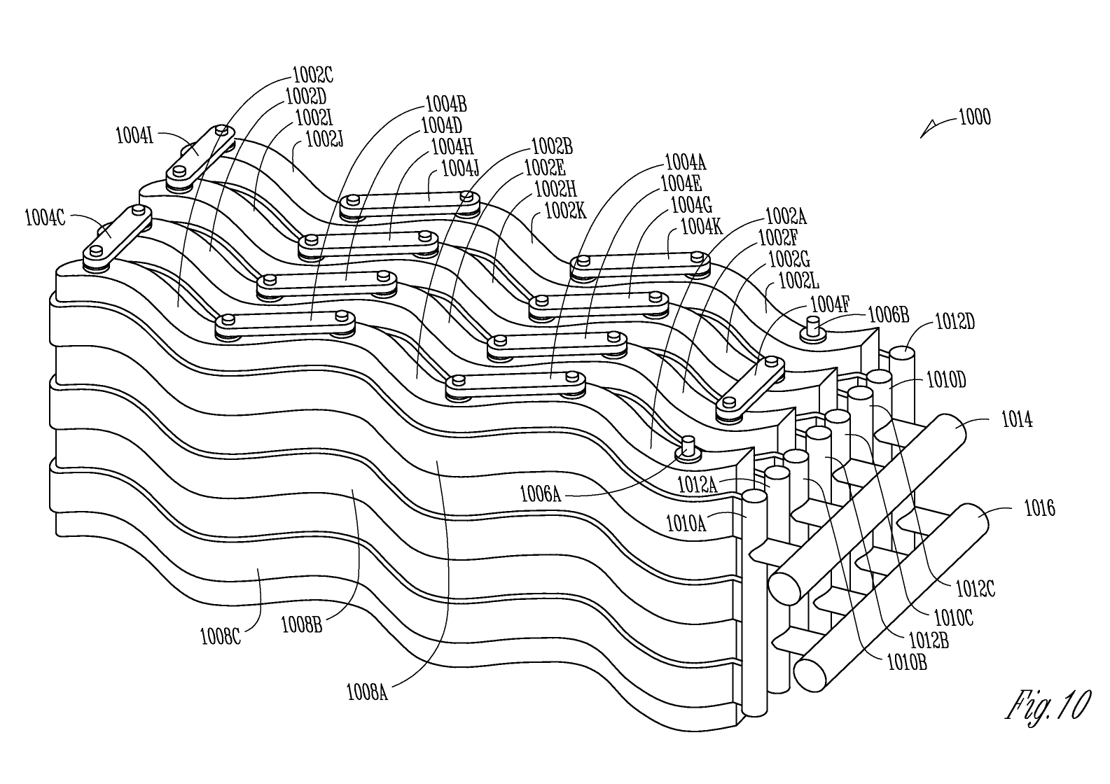

FIGS. 9 and 10 show examples of portions of BTM systems 900 and 1000, respectively, in accord with one or more embodiments. The cells 902A, 902B, 902C, 902D, 902E, 902F, 902G, 902H, 902J, 902K, and 902L and the cells 1002A, 1002B, 1002C, 1002D, 1002E, 1002F, 1002G, 1002H, 1002J, 1002K, and 1002L can be substantially the same as the cells 702A-C with the cells 902A-L and 1002A-L including irregular shapes. The minichannel tubes 908A, 908B, 908C and 1008A, 1008B, and 1008C can be substantially the same as the minichannel tubes 708A-C with the minichannel tubes 908A-C and 1008A-C including a shape that follows the contours of the cells 902A-L and 1002A-L, respectively. These FIGS. are intended to demonstrate that the minichannel tubes 708A-C, 808A-C, 908A-C, and 1008A-C can be used on non-standard cells and can fit a wide variety of cell shapes. Some minichannel tube shapes can create issues such as pressure drops or turbulence within the tube, such as to be less efficient or even impractical in use.

The connectors 904A, 904B, 904C, 904D, 904E, 904F, 904G, 904H, 904I, 904J, and 904K and 1004A, 1004B, 1004C, 1004D, 1004E, 1004F, 1004G, 1004H, 1004I, 1004J, and 1004K can be substantially the same as the connectors 704A-B; the terminals 906A and 906B and 1006A and 1006B can be substantially the same as the terminals 706A-B; the input ports 910A, 910B, 910C, and 910D and 1010A, 1010B, 1010C, and 1010D can be substantially the same as the input port 710; the output ports 912A, 912B, 912C, and 912D and 1012A, 1012B, 1012C, and 1012D can be substantially the same as the output port 712; the input tubes 914 and 1014 can be substantially the same as the input tube 814; and the output tubes 916 and 1016 can be substantially the same as the output tube 816. The ports 910A-D, 912A-D, 1010A-D, and 1012A-D, and the tubes 914, 916, 1014, and 1016 can include the same materials as the minichannel tubes 708A-C, and can also include other materials. The ports 710, 712, 810A-C, 812A-C, 910A-D, 912A-D, 1010A-D, and 1012A-D, or the tubes 914, 916, 1014, and 1016 can be insulated, such as to help a temperature of a fluid therein remain constant.

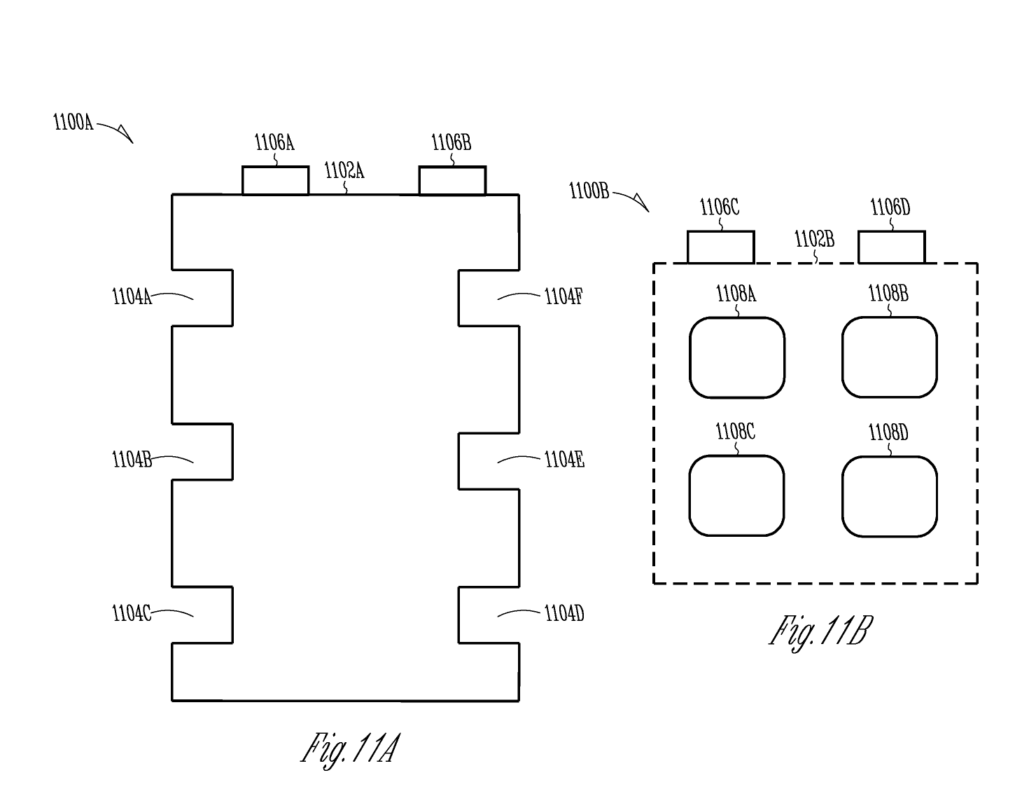

FIG. 11A shows an example of a battery 1100A, in accord with one or more embodiments. The battery 1100A can include a cell 1102A that includes one or more recesses 1104A, 1104B, 1104C, 1104D, 1104E, or 1104F and one or more terminals 1106A and 1106B. A minichannel tube 708A-C, 808A-C, 908A-C, or 1008A-C can be slotted at least partially into the recess 1104A-F. By slotting the tube 708A-C, 808A-C, 908A-C, or 1008A-C in the recess 1104A-F, the tube 808A-C, 908A-C, or 1008A-C can have more surface area contacting the cell 1102A and thus, can provide more efficient heating or cooling. While FIG. 11A depicts the recess 1104A-F as including a rectangular shape, a recess 1104A-F can include another shape, such as an ellipse, rounded corner shapes, a polygon, an irregular shape, or a combination thereof, among others.

FIG. 11B shows an example of a battery 1100B, in accord with one or more embodiments. The battery 1100B can include a cell 1102B that includes one or more minichannel tubes 1108A, 1108B, 1108C, or 1108D internal to the cell 1102B and one or more terminals 1106A and 1106B. The minichannel tube 1108A-D can be in contact with an electrolyte of the cell 1102B. (The electrolyte is not shown to avoid obscuring the FIG.). The minichannel tube 1108A-D can be substantially the same as the minichannel tube 708A-C, 808A-C, 908A-C, or 1008A-C. By making the tube 1108A-D internal to the cell 1102B the tube 1108A-D can have more surface area contacting the cell 1102B and thus, can provide more efficient heating or cooling. Also, the tubes 1108A-D can be situated anywhere internal to the cell 1102B, such as to provide a configurable heat profile internal to the cell 1102A-D. The tube 1108A-D can be positioned such that it is closer to a typically warmer or cooler spot of the cell 1102B, such as to help more efficiently keep the cell 1102B within a specified temperature range. When using a tube 1108A-D internal to the cell 1102B, care should be taken to make sure that the material of the tube is compatible with the chemistry of the battery 1100B. For example, and aluminum tube can be used internal to a Li-ion battery because the Li-ion battery chemistry will not substantially corrode or damage the aluminum tube.

FIG. 12 shows an example of a BTMS 1200, in accord with one or more embodiments. The BTMS 1200 can include a battery that includes one or more cells 1202A and 1202B, one or more connectors 1204A, and one or more terminals 1206A and 1206B. The cell 1202A-B can be thermally coupled to one or more minichannel tubes 1208A, 1208B, or 1208C. The tubes 1208A-C can be coupled to a pump 1214 through an input port 1210 and an output port 1212. The pump 1214 can move the fluid in the tubes 1208A-C. The pump 1214 can be a reciprocating, rotary, or shear force pump, among others. The system 1200 can include multiple pumps, such as to provide the ability to individually vary the flow rate of fluid in each of the minichannel tubes. The cells 1202A-B can be substantially the same as the cells 702A-C, 808A-F, 902A-L, or the cells 1002A-L. The minichannel tubes 1208A-C can be substantially the same as the tubes 708A-C, 808A-C, 908A-C, or 1008A-C. The input port 1210 can be substantially the same as the input port 710, 810A-C, 910A-D, or 1010A-D. The output port 1212 can be substantially the same as the output port 712, 812A-C, 912A-D, or 1012A-D. The connector 1204A can be substantially the same as the connector 704A-B, 804A-G, 904A-K, or 1004A-K. The terminal 1206A-B can be substantially the same as the terminal 706A-B, 806A-B, 906A-B, or 1006A-B.

Fluid can be pumped from the pump 1214 to the heater/chiller 1216. The heater/chiller 1216 can sense the temperature of the fluid (using a temperature sensor not shown in FIG. 12) and heat/cool the fluid to within a specified temperature range or heat/cool the fluid based on control signals from the processor 1228. The flow regulator 1218 can increase or decrease a flow rate of fluid from the heater/chiller 1216. The flow regulator 1218 can help keep a flow of fluid in the tubes 1208A-C laminar The flow regulator 1218 can be communicatively coupled to the flow meter 1220. The flow meter 1220 can provide data to the processor 1228 that can be used to help keep the flow of the fluid within a specified range. The filter 1222 can remove particulates from the fluid, so as to help prevent clogging or turbulence in the fluid (e.g., particle generated shedding from interior walls of the system 1200 or particles incurred or contained within the fluid). The pressure transducer 1224 can be communicatively coupled to the pump 1214 and flow regulator 1218. The pressure transducer can determine a pressure of fluid in the ports 1210 and 1212 or the tubes 1208A-C. The pressure transducer 1224 can provide data to the processor 1228 that can be used to help control the pump 1214 or the flow regulator 1218, such as to help keep the flow of fluid within a specified range.

The pore size of the filter 1222 (e.g., determined from a particle size to be filtered within the minichannel tubes 1208A-B) can be determined based on a number of factors. Although a smaller pore size within a filter can reduce the number of particulates within the BTMS, the smaller pore size can also increase the pressure drop, and consequently, the power needed to recirculate the fluid through the system. Therefore, a figure of merit (e.g., filtration efficiency as a function of pressure drop) can be considered in designing a given BTMS for a given system. Also, multiple filters arranged in parallel, or alternatively or in addition, a filter with a larger surface area, can be considered.

The load 1226 can be any item that can drain the power of the cell 1202A-B, such as an EV or other item discussed herein. The processor 1228 can include hardware, software, firmware, or a combination thereof. The processor 1228 can provide a signal to the pump 1214, such as to control a rate at which the pump operates. The processor 1228 can provide a signal to the heater/chiller 1216, such as to control a temperature setting of the heater/chiller 1216. The processor 1228 can provide a signal to the flow regulator 1218, such as to control a rate at which the flow regulator 1218 slows the flow of the fluid. The processor 1228 can receive data from the pressure transducer 1224, the flow meter 1220, or a temperature sensor (not shown in FIG. 12, see FIG. 13) that can be used by the processor 1228 to help control the flow rate of the fluid, temperature of the fluid, or the pressure in the tubes 1208A-C. The pump 1214, processor 1228, heater/chiller 1216, flow regulator 1218, or flow meter 1220 can be powered by the cell 1202A-B or another power source.

FIG. 13 shows an example of a BTMS 1300, in accord with one or more embodiments. The BTMS 1300 can include a battery that includes one or more cells 1302A and 1302B, one or more connectors 1304A, and one or more terminals 1306A and 1306B. The cell 1302A-B can be thermally coupled to one or more minichannel tubes 1308A, 1308B, or 1308C. The tubes 1308A-C can be coupled to a pump 1314 through an input port 1310 and an output port 1312. The pump 1214 can move the fluid in the tubes 1308A-C. The pump 1314 can be a reciprocating, rotary, or shear force pump, among others.

The pump 1314 can provide fluid to a valve 1318. The valve 1318 can direct the fluid to a chiller 1316, if the fluid is to be cooled, a radiator 1324, if heat is to be dissipated from the fluid, or a heater 1320, if the fluid is to be heated. The temperature sensor 1326 can help determine a temperature of the cell 1302A-B. The temperature sensor 1326, pump 1314, valve 1318, chiller 1316, and heater 1320 can each be electrically or communicatively coupled to a processor (not shown in FIG. 13, see FIG. 12). The processor can control a rate (e.g., a volumetric or a mass flow rate) of the pump. The processor can control the valve 1318, such as to control a direction of fluid flow out of the valve 1318 (e.g., to open or close a valve output to direct the fluid to the heater 1320, radiator 1324, or chiller 1316). The processor can be coupled to the chiller 1316 to control how much the chiller 1316 cools the fluid. The processor can be coupled to the heater 1320 to control how much the heater 1320 heats the fluid. The temperature sensor 1326 can provide data to help the processor control the heater 1320 and chiller 1316 and keep the fluid within a specified temperature range.

The cells 1302A-B can be substantially the same as the cells 702A-C, 808A-F, 902A-L, or the cells 1002A-L. The minichannel tubes 1308A-C can be substantially the same as the tubes 708A-C, 808A-C, 908A-C, or 1008A-C. The input port 1310 can be substantially the same as the input port 710, 810A-C, 910A-D, or 1010A-D. The output port 1312 can be substantially the same as the output port 712, 812A-C, 912A-D, or 1012A-D. The connector 1304A can be substantially the same as the connector 704A-B, 804A-G, 904A-K, or 1004A-K. The terminal 1306A-B can be substantially the same as the terminal 706A-B, 806A-B, 906A-B, or 1006A-B.

Note that the items of FIGS. 12 and 13 are not mutually exclusive. Items not shown in FIG. 12 but shown in FIG. 13 can be used in the system of FIG. 12 and vice versa. Also, not all the items of FIGS. 12 and 13 are required to make an operational BTMS. Some of the items can be optional depending on the constraints of the BTMS. For example, if the items of a BTMS do not have very stringent pressure constraints, a pressure transducer can be omitted from the BTMS.

The fluid flow rate of the fluid can be dynamic to keep a measured temperature of the cells 1302A-B under dynamic working conditions at a pre-determined level. In addition, due to the non-uniform heat generation that can occur inside a cell, the minichannel tube geometry, tube configuration, and flow rate could be adjusted to reduce or minimize uneven temperature distribution in each cell. Furthermore, minichannel technology not only could cool a cell from outside of the cell, but also could be embedded inside the cell (as shown in FIG. 11B) to achieve more efficient cooling from inside the cell.

The temperature sensing, such as by temperature sensor 1326, of the cells can be accomplished by, for example, employing thermocouples, resistance temperature detectors, or other temperature sensing devices known in the art. The fluid in the minichannel tubes can be heated or cooled while passing near the cells, the heat carried by the fluid can be dumped to a radiator (e.g., a heat exchanger) connected to a fan or a heating/cooling loop, and a portion of the heat can be dissipated through a channel that carries the fluid between items of the BTMS.

A pump can be used to recirculate the fluid within the minichannel tubes. Various types of pumps can be employed. The pump can be either upstream and/or downstream from the cells. Also, additional pumps can be used on various ones of the one or more minichannel tubes depending on various flow rates that can be required. Optionally, flow regulation valves can be placed on one or more of the minichannel tubes to provide various flow rates for a given one of the minichannel tubes within the BTMS. In various embodiments, a determination of various relative flow rates between various minichannel tubes within the BTMS can be known in advance (e.g., for a given battery for a given EV). In this case, various sizes (e.g., related to given flow rates for a given upstream/downstream pressure) of a critical orifice can be used in selected ones of the minichannel tubes to provide a relative flow difference between the various minichannel tubes.

In the case of use within an EV, the batteries of the EVs can be used to drive a pump to recirculate the fluid within the minichannel tubes. In other embodiments, a separate power supply, such as a photovoltaic cell with a charge storage system, outlet power, or a separate battery, can be used to power the pump. Also, the BTMS can be adapted to provide heat transfer to the cell rather than from the cell. Such a “reverse” heat transfer system (e.g., heating the cells) can be useful in cold climates. Therefore, the BTMS can be designed to incorporate heat transfer both to and from the cell. For example, the BTMS can use electrical resistive heating by thermally coupling resistive heaters in only portions or on the entire outside surfaces of the minichannel tubes that are not in mechanical or physical contact with the cells. In various embodiments, the fluid within the minichannel tubes can be remotely heated at, for example, nearby the filter or pump. In various embodiments, both remote heating and resistive heating proximate the cells can be employed in processes the same or similar to the cooling processes discussed above.

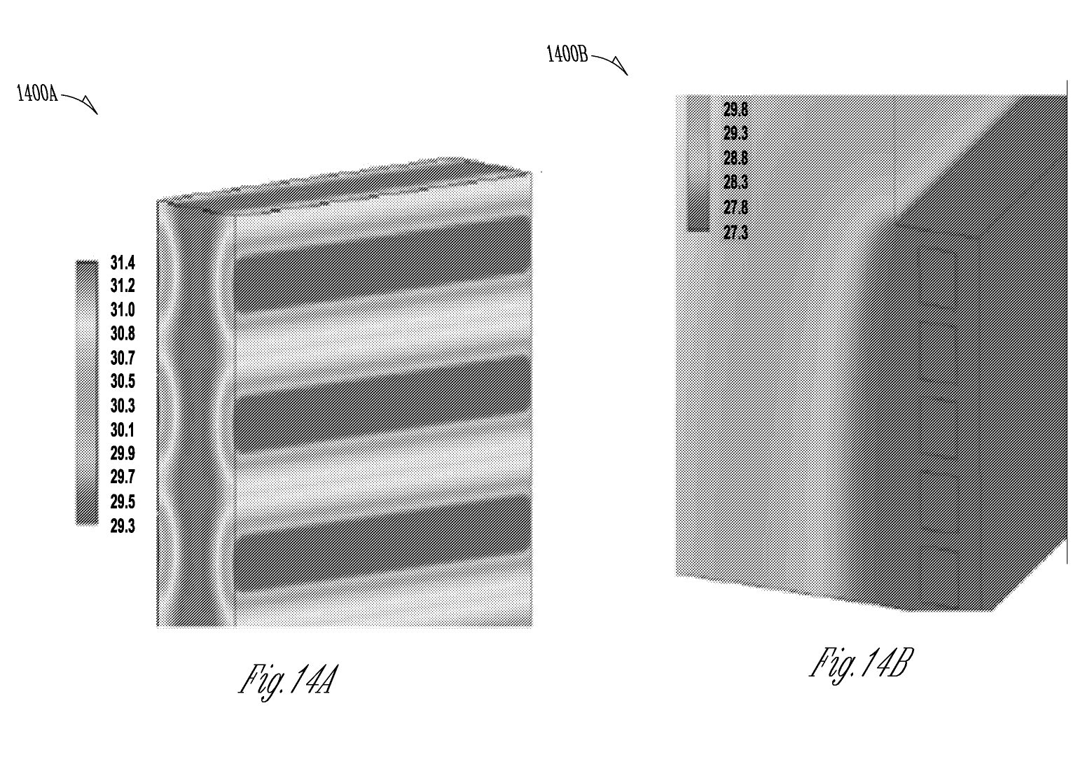

FIGS. 14A and 14B show examples of simulated thermal diagrams 1400A and 1400B of a simulation of a prismatic cell including minichannel tubes thermally coupled thereto and a more localized view of the thermal profile near a minichannel tube, respectively, in accord with one or more embodiments. The numerical results can show that more efficient cooling using minichannel technologies as compared to a previous BTMS. An analysis is provided herein to help describe the governing equations and simulations used to generate FIGS. 14A and 14B.

What follows is an analysis of some design considerations in creating a BTMS, reference is made to some of the figures to help in understanding the analysis. Fluid flow in minichannel tubes generally falls in a laminar flow regime due to a low Reynolds number (Re). In the laminar flow, the local heat transfer coefficient, h, varies inversely with the tube diameter (i.e. h α 1/D) as shown in FIG. 6A. For a fully developed laminar flow in a straight tube, the pressure drop (ΔP) can be computed using Equation 1: ΔP=32*μ*V*L/D² where μ is the flow viscosity, V is the flow velocity, L is the tube length, and D is port hydraulic diameter. FIG. 6B illustrates the pressure drop vs. port diameter at a fixed flow velocity and port length. For some thermal management systems, effects from inlet and outlet plenums, and port curvatures, can be considered in the estimation of pumping power requirements. While minichannel tube fluid flow has an advantage of a high heat transfer coefficient, the minichannel tube can cause a high pressure drop and require high parasitic pumping power, which poses an obstacle that can be at least partially overcome through reducing tube length or flow velocity, such as can be based on the pressure drop equation.

FIG. 5 shows the dimensions of a minichannel tube as previously discussed. The dimensions are presented again for convenience. The dimensions can include an overall width 502 (W), a spacing 508 (W_{w}) between ports, a thickness 510 (Wₜ) of a sidewall 512, a width 514 (W_{c}) of the port 504A-K, and a height 516 (H_{c}) of the port 504A-K. Another parameter includes the length of the port (L). Different combinations of these design parameters can lead to a large search space for optimization, such as can be accomplished using a nonlinear search algorithm.

An empirical model for pressure drop (ΔP) and temperature increase ΔTₘₐₓ is explained herein. A synergetic numerical simulation using commercial COMSOL Multiphysics® software (available from COMSOL, Inc., Burlington, Mass., U.S.A.) and experiments were conducted to explore the empirical model and the feasibility of applying the minichannel tube to a BTMS. A 50/50 EG/W solution was used as the fluid. With numerical results as guidelines, a prototype lab-scale cooling system was fabricated and tested to validate and calibrate the two empirical models. Cost analyses of the new BTMS is explained and compared with that of a conventional BTMS with fluid cooling using the BatPaC cost model developed by the U.S. Department of Energy (DOE) Argonne National Laboratory. The feasibility of minichannel cooling for the BTMS was confirmed based on the study.

Numerical modeling and simulation of battery heat generation and transport is a tool that can be used to help find a way to enhance overall battery performance, safety, and life. The Batteries & Fuel Cells Module and Heat Transfer Module incorporated in the COMSOL Multiphysics® software provided a set of tools which were applied to simulate heat generation processes due to chemical reactions and heat transport processes involving diffusion, convection, and radiation.

In general, there are two common types of Li-ion cells: a cylindrical cell with smaller charge capacity (e.g., less than 5 Ah) and a prismatic cell with larger charge capacity (e.g., greater than 10 Ah). Heat generation and transport was studied in a cylindrical cell using COMSOL to obtain some preliminary results. However, the greater charge capacity of a prismatic cell, makes it more widely applicable, such as for EVs with large a battery pack, such as to help achieve a larger driving range (e.g., around 250 miles to about 300 miles).

A lab-scale minichannel cooling system for two prismatic cells in series connection was studied to find ΔTₘₐₓ and ΔP. The overall thermal resistance (R₀) is defined as follows in Equation 2: R₀=ΔTₘₐₓ/Qₕₑₐₜ where Qₕₑₐₜ is total battery heat generation rate. The maximum temperature increase (ΔTₘₐₓ) at different heating conditions can be estimated based on Eq. (2) once R₀ is given or known. The total thermal resistance, R₀, can be divided into four components as shown in Equation 3: R₀=R_{Cell}+R_{base}+R_{EG/W}+R_{Conv} where R_{Cell} and R_{base} represent conductive thermal resistance of the cell and minichannel base, respectively, R_{EG/W} is caloric thermal resistance of EG/W coolant, and R_{Conv} is convective thermal resistance. While it is straight forward to estimate the first three components in Eq. (3), research efforts may be employed to find R_{Conv}. A common and convenient method of characterizing convective heat transfer is through a non-dimensional Nusselt number (Nu). R_{Conv} can be calculated from Nu by integration along a minichannel axis.

The pressure drop in a minichannel tube can be calculated by using a friction factor (f) for fully developed laminar flow as in Equation 4: ΔP=f*(L/Dₕ)*(0.5*ρ_{f}*V²) where ρ_{f} is fluid density and Dₕ is the hydraulic diameter. Dₕ can be determined using Equation 5: Dₕ=(2*α*W_{c})/(1+α) where α=H_{c}/W_{c} the aspect ratio of the minichannel.

Results from a heat transfer simulation based on these Equations is presented in FIGS. 14A and 14B. The simulation was completed using the COMSOL Multiphysics® software. FIGS. 14A and 14B depict a simulation of minichannels on a single prismatic cell with water cooling through three minichannel tube stripes.

An empirical model for convective heat transfer coefficient (Nu) and friction factor f, respectively, can be created. Specifically, convective heat transfer can be modelled as a function of a Reynolds number, Re (Re=ρ_{f}*V*Dₕ/μ), a Prandtl number, Pr (Pr=Cₚ*μ/k where Cp and k are specific heat and thermal conductivity of EG/W, respectively).

Using numerical simulations as design guideline, a BTMS can be designed. A prototype BTMS included a minichannel tube geometry of Wc=1.33 mm, Hc=2.72 mm, Ww=0.25 mm, Wt=0.51 mm, and W=25.40 mm (see FIG. 5 for the corresponding dimensions). The minichannel tubes were welded with two slotted aluminum tubes functioning as inlet and outlet ports. A schematic of the cooling loop is shown in FIG. 12. A gear pump was used to drive 50/50 EG/W solution inside the loop. The flow velocity was controlled by a flow regulator valve and the volume flow rate measured by a flow meter. A flow filter was used to prevent minichannel tubes from clogging. The pressure drop (ΔP) across the minichannels was monitored by a pressure transducer. A water bath (e.g., a heater/chiller) with a generally constant temperature was used to keep the EG/W solution at a constant temperature at the inlet of minichannel tubes. The two-battery in-series connection was connected to a computer controlled battery cycler (e.g., a load) to run programmed change/discharge cycles. The temperature in the manifolds (e.g., input port 1210A and output port 1212A) was measured with thermocouples. The data for pressure and temperature measurements were collected using computer software (e.g., CompactDAQ module and LABVIEW available from National Instruments®, Austin, Tex., U.S.A.). The temperature change in the batteries was recorded by an infrared camera. The batteries and minichannel tube cooling device were covered by a thermal insulation layer to help reduce external environmental effects.

While the foregoing description is with regard to a lab-scale BTMS, the same or similar empirical models can be applied to design a full-scale BTMS for any other battery pack by scaling up from the lab-scale cooling system. In a scaled-up BTMS, a second (or more) refrigerant loop or a heater can be used to help control the fluid temperature at different battery operating conditions.

The studies discussed herein indicated that a BTMS discussed herein can be more compact and lighter than a conventional cooling system. Also, the projected manufacturing cost of the new cooling system can be 20% lower than that of a conventional fluid cooling system or more.

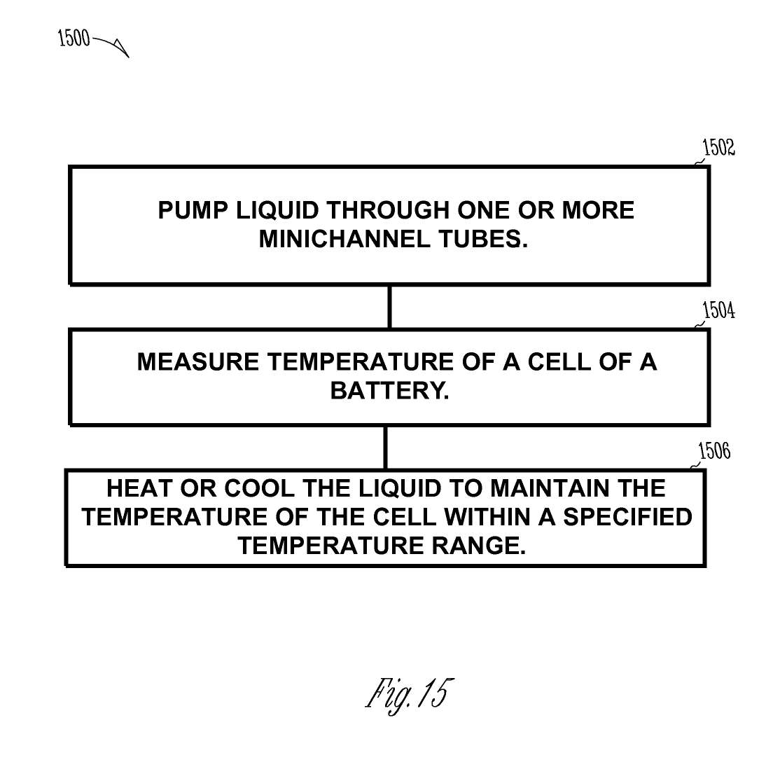

FIG. 15 shows a flow diagram of an example of a method 1500, in accord with one or more embodiments. The method 1500 as illustrated includes: pumping a fluid though one or more minichannel tubes at operation 1502; measuring a temperature of a cell of a battery at operation 1504, and changing a temperature of the fluid (e.g., heating or cooling the fluid) to maintain the temperature of the cell within a specified temperature range at operation 1506. The one or more minichannel tubes can be thermally coupled to one or more cells of a battery pack. The cell can be a cell of the one or more cells.

The method 1500 can include individually varying the flow rate of the fluid in each of the one or more minichannel tubes. The operation at 1506 can include heating or cooling the one or more cells using a minichannel tube of the one or more minichannel tubes that is at least partially internal to the cell, such as to be in contact with an electrolyte of the one or more cells. A minichannel tube of the one or more minichannel tubes is situated in a recess of a cell of the one or more cells. The one or more cells can be lithium ion cells. The specified range can be about 20 degrees Celsius to about 30 degrees Celsius. The fluid can include an EG/W fluid.

Although the Battery Thermal Management (BTM) systems, apparatuses, and methods discussed herein are described in terms of use on EV systems, the BTMs can be used for various types of heat transfer (heating and cooling) operations on numerous other types of batteries as well as other apparatuses and systems. One application can include energy storage to improve the battery performance and lifespan. Other apparatuses and systems include, but are not limited to, submersible vehicles (e.g., submarines), unmanned vehicles (e.g., unmanned aerial, ground, or submersible vehicles or devices), aerial vehicles (e.g., passenger planes, military planes, helicopters, cargo planes, etc.), remote controlled devices, or other devices that include one or more batteries and can benefit from a BTM system. Therefore, the BTMs are not limited to use only on EV batteries, the BTMs were described for use on EV batteries simply for ease in understanding the concepts, systems, and methodologies presented. Also, even for use in an EV BTM, the accompanying disclosure is readily applicable to other types of batteries and, therefore, should not be considered to be limited only to lithium or lithium compound-based batteries. The analysis herein relates to lithium or lithium compound based batteries, but can be recreated using another battery technology. Note that other battery technologies can have optimum operating and storage temperatures that are different from lithium technologies. Such variation can be accommodated by changing a fluid used for cooling and programming a controller to heat or cool the fluid consistent with the fluid chosen and the target temperature range of the battery.

### Additional Notes

The present subject matter can be described by way of several examples.

Example 1 can include or use subject matter (such as an apparatus, a method, a means for performing acts, or a device readable memory including instructions that, when performed by the device, can cause the device to perform acts), such as can include or use one or more minichannel tubes configured to be thermally coupled with one or more cells within a battery pack, a temperature sensor to measure a temperature of the one or more cells, or a pump to vary a flow rate of fluid within the one or more minichannel tubes based on the measured temperature from the temperature sensor to maintain the temperature of the one or more cells within a specified temperature range.

Example 2 can include or use, or can optionally be combined with the subject matter of Example 1, to include or use, a filter to remove a particulate from the fluid.

Example 3 can include or use, or can optionally be combined with the subject matter of at least one of Examples 1 and 2, to include or use, wherein the pump is to individually vary the flow rate of the fluid in each of the one or more minichannel tubes.

Example 4 can include or use, or can optionally be combined with the subject matter of at least one of Examples 1 through 3, to include or use, wherein the one or more minichannel tubes are to change a temperature a cell of the one or more cells.

Example 5 can include or use, or can optionally be combined with the subject matter of at least one of Examples 1 through 4, to include or use, wherein the minichannel tubes are at least partially internal to a cell of the one or more cells so as to be in contact with an electrolyte of the cell.

Example 6 can include or use, or can optionally be combined with the subject matter of at least one of Examples 1 through 5, to include or use, wherein a minichannel tube of the one or more minichannel tubes are situated in a recess of a cell of the one or more cells.

Example 7 can include or use, or can optionally be combined with the subject matter of at least one of Examples 1 through 6, to include or use, wherein the one or more minichannel tubes are generally “U” shaped and thermally coupled to at least two sides of a cell of the one or more cells.

Example 8 can include or use, or can optionally be combined with the subject matter of at least one of Examples 1 through 7, to include or use, wherein the minichannels include a hydraulic diameter of about 0.2 millimeters to about 3.0 millimeters.

Example 9 can include or use, or can optionally be combined with the subject matter of at least one of Examples 1 through 8, to include or use, wherein a thickness of a wall of the one or more minichannels is about 100 micrometers to about 200 micrometers.

Example 10 can include or use, or can optionally be combined with the subject matter of at least one of Examples 1 through 9, to include or use, wherein the one or more cells are lithium ion cells and the specified range is about 20 degrees Celsius to about 30 degrees Celsius.

Example 11 can include or use, or can optionally be combined with the subject matter of at least one of Examples 1 through 10, to include or use, wherein the one or more minichannel tubes include walls independent of walls of the one or more cells.

Example 12 can include or use subject matter (such as an apparatus, a method, a means for performing acts, or a device readable memory including instructions that, when performed by the device, can cause the device to perform acts), such as can include or use pumping a fluid through one or more minichannel tubes, the one or more minichannel tubes thermally coupled with one or more cells of a battery pack, measuring a temperature of a cell of the one or more cells, or changing the temperature of the fluid to maintain the temperature of the one or more cells within a specified temperature range.

Example 13 can include or use, or can optionally be combined with the subject matter of Example 12, to include or use individually varying the flow rate of the fluid in each of the one or more minichannel tubes.

Example 14 can include or use, or can optionally be combined with the subject matter of at least one of Examples 12 and 13, to include or use, wherein changing the temperature of the fluid includes changing the temperature of the fluid to change the temperature of a minichannel tube of the one or more minichannel tubes, wherein the minichannel tube is situated at least partially internal to the one or more cells so as to be in contact with an electrolyte of the one or more cells.

Example 15 can include or use, or can optionally be combined with the subject matter of at least one of Examples 12 through 14, to include or use, wherein a minichannel tube of the one or more minichannel tubes is situated in a recess of a cell of the one or more cells.

Example 16 can include or use, or can optionally be combined with the subject matter of at least one of Examples 12 through 15, to include or use, wherein the one or more cells are lithium ion cells and the specified range is about 20 degrees Celsius to about 30 degrees Celsius.

Example 17 can include or use subject matter (such as an apparatus, a method, a means for performing acts, or a device readable memory including instructions that, when performed by the device, can cause the device to perform acts), such as can include or use one or more battery cells and one or more minichannel tubes attached to the one or more battery cells so as to be thermally coupled to the one or more battery cells.

Example 18 can include or use, or can optionally be combined with the subject matter of Example 17, to include or use, wherein a battery cell of the one or more battery cells includes a recess in a sidewall thereof, and wherein a minichannel tube of the one or more minichannel tubes is situated at least partially in the recess so as to contact the battery cell in the recess.

Example 19 can include or use, or can optionally be combined with the subject matter of at least one of Examples 17 through 18, to include or use, wherein a minichannel tube of the one or more minichannel tubes is situated at least partially within a battery cell of the one or more battery cells so as to contact an electrolyte in the battery.

Example 20 can include or use, or can optionally be combined with the subject matter of at least one of Examples 17 through 19, to include or use, wherein the one or more battery cells are lithium ion battery cells and wherein the one or more minichannel tubes include aluminum.

Example 21 can include or use subject matter (such as an apparatus, a method, a means for performing acts, or a device readable memory including instructions that, when performed by the device, can cause the device to perform acts), such as can include or use a plurality of rows of battery cells arranged in an array, and one or more minichannel tubes situated between adjacent rows of the plurality of rows of battery cells so as to be in thermal contact with cells in both of the adjacent rows simultaneously.

Example 22 can include or use, or can optionally be combined with the subject matter of Example 21, to include or use, a plurality of input ports and output ports, wherein each minichannel tube is connected to an input port of the plurality of input ports and an output port of the plurality of output ports such that fluid can flow from the input port through the minichannel tube and to the output port.

Example 23 can include or use, or can optionally be combined with the subject matter of Example 22, to include or use, a pump coupled to the plurality of input ports so as to pump the fluid to the plurality of input ports.

Example 24 can include or use, or can optionally be combined with the subject matter of at least one of Examples 21 through 23, to include or use, wherein the minichannel tubes are generally “U” shaped and configured to thermally contact two, opposite sides of cells in a row of the plurality of rows of battery cells.

Although an overview of the subject matter has been described with reference to specific embodiments, various modifications and changes can be made to these embodiments without departing from the broader spirit and scope of the present disclosure.

The embodiments illustrated herein are described in sufficient detail to enable those skilled in the art to practice the teachings disclosed. Other embodiments can be used and derived therefrom, such that structural and logical substitutions and changes can be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances can be provided for resources, operations, or structures described herein as a single instance. Additionally, boundaries between various resources, items with reference numbers, or operations, are somewhat arbitrary, and particular operations are illustrated in a context of specific illustrative configurations. Other allocations of functionality are envisioned and can fall within a scope of various embodiments of the present invention. In general, structures and functionality presented as separate resources in the example configurations can be implemented as a combined structure or resource. Similarly, structures and functionality presented as a single resource can be implemented as separate resources.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, the terms “first,” “second,” and “third,” etc. are used merely as labels, and are not intended to impose numerical requirements on their objects.

These and other variations, modifications, additions, and improvements fall within a scope of the inventive subject matter as represented by the appended claims. The specification and drawings are, accordingly, to be regarded in an illustrative rather than a restrictive sense.

1. A battery thermal management system comprising:
one or more minichannel tubes configured to be in thermal contact with one or more cells within a battery pack;
a temperature sensor to measure a temperature of the one or more cells; and
a pump to vary a flow rate of fluid within the one or more minichannel tubes based on the measured temperature from the temperature sensor to maintain the temperature of the one or more cells within a specified temperature range.

2. The system of claim 1, further comprising a filter to remove a particulate from the fluid.

3. The system of claim 1, wherein the pump is to individually vary the flow rate of the fluid in each of the one or more minichannel tubes.

4. The system of claim 1, wherein the one or more minichannel tubes are to change a temperature of a cell of the one or more cells.

5. The system of claim 1, wherein the minichannel tubes are at least partially internal to a cell of the one or more cells so as to be in contact with an electrolyte of the cell.

6. The system of claim 1, wherein a minichannel tube of the one or more minichannel tubes are situated in a recess of a cell of the one or more cells.

7. The system of claim 1, wherein the one or more minichannel tubes are generally “U” shaped and thermally coupled to at least two sides of a cell of the one or more cells.

8. The system of claim 1, wherein the one or more minichannel tubes each include a hydraulic diameter of about 0.2 millimeters to about 3.0 millimeters.

9. The system of claim 1, wherein a thickness of a wall of each of the one or more minichannels is about 100 micrometers to about 200 micrometers.

10. The system of claim 1, wherein the one or more cells are lithium ion cells and the specified temperature range is about 20 degrees Celsius to about 30 degrees Celsius.

11. The system of claim 1, wherein the one or more minichannel tubes include walls independent of walls of the one or more cells.

12. A method of managing a temperature of a battery cell, the method comprising:
pumping a fluid through one or more mini channel tubes, the one or more minichannel tubes configured to thermally contact one or more cells of a battery pack;
measuring a temperature of a cell of the one or more cells; and
changing the temperature of the fluid to maintain the temperature of the one or more cells within a specified temperature range.

13. The method of claim 12, further comprising individually varying the flow rate of the fluid in each of the one or more minichannel tubes.

14. The method of claim 12, wherein changing the temperature of the fluid includes changing the temperature of the fluid to change the temperature of a minichannel tube of the one or more minichannel tubes.

15. The method of claim 12, wherein at least one of the one or more minichannel tubes is situated at least partially internal to the one or more cells so as to be in contact with an electrolyte of the one or more cells.

16. The method of claim 12, wherein a minichannel tube of the one or more minichannel tubes is situated in a recess of a cell of the one or more cells.

17. The method of claim 12, wherein the one or more cells are lithium ion cells and the specified temperature range is about 20 degrees Celsius to about 30 degrees Celsius.

18. A device comprising:
one or more battery cells;
one or more minichannel tubes attached to the one or more battery cells so as to thermally contact the one or more battery cells; and
an input port coupled to the one or more minichannel tubes, the input port configured to receive fluid from a pump and guide the fluid to the one or more minichannel tubes.

19. The device of claim 18, wherein a battery cell of the one or more battery cells includes a recess in a sidewall thereof, and wherein a minichannel tube of the one or more minichannel tubes is situated at least partially in the recess so as to contact the battery cell in the recess.

20. The device of claim 18, wherein a minichannel tube of the one or more minichannel tubes is situated at least partially within a battery cell of the one or more battery cells so as to contact an electrolyte in the battery.

21-25. (canceled)
